(19) United States
(12) Patent Application Publication
(10) Pub. No.: US 2017/0114899 A1
(43) Pub. Date: Apr. 27, 2017

(54) Elastic Integrated Molded Baffler and Sealer

(71) Applicant: Zephyros, Inc., Romeo, MI (US)

(72) Inventors: Gary Vanlerberghe, Melvin, MI (US); Erin Matthew White, Wales Township, MI (US)

(21) Appl. No.: 15/299,962

(22) Filed: Oct. 21, 2016

Related U.S. Application Data
(60) Provisional application No. 62/245,003, filed on Oct. 22, 2015.

(51) Int. Cl. F16J 15/02

(52) U.S. Cl. CPC F16J 15/022; B60J 10/15

(57) ABSTRACT

A device for sealing or baffling a cavity comprising a first attachment portion, a second attachment portion opposing the first attachment portion and an elastic portion located in between the first and second attachment portions so that the length of the elastic portion can be modified during installation.

### TECHNICAL FIELD

The present invention relates generally to a baffling and sealing member that includes a plurality of attachments means and an elastic portion for selecting the length of the member during installation

### BACKGROUND

The transportation industry continues to require methods of baffling, reinforcement and sealing that provide improved functionality while simultaneously providing reduced weight and cost. In the sealing and baffling area, it is typical that a specific baffle/sealer is designed to specifically meet the sizing needs of a particular cavity requiring baffling and/or sealing. Thus each cavity requires its own specific part design.

It would thus be desirable to create a baffling and/or sealing device that can be modified easily during installation so that it can fit within a variety of different cavities, thus limiting the need for a different baffle/seal for every cavity.

### SUMMARY OF THE INVENTION

In a first aspect, the present invention contemplates a device for sealing or baffling a cavity comprising a first attachment portion, a second attachment portion opposing the first attachment portion and an elastic portion located in between the first and second attachment portions so that the length of the elastic portion can be modified during installation. The elastic portion may comprises an activatable material and may be integrally formed with the first and second attachment portion. One or more of the first and second attachment portions may include an opening. Both of the first and second attachments may include an opening. One or more of the first and second attachment portions may include at least one integrally formed projection. Both of the first and second attachment portions include at least one integrally formed projection. The at least one integrally formed projection may extend outward from an opening. The entirety of the device may be integrally formed of one material. The entirety of the device may be integrally formed of an activatable material. The entirety of the device may be integrally formed of an activatable material that foams and/or cures upon exposure to elevated temperatures. The elastic portion may be formed in an accordion shape to allow for the length of the elastic portion to be increased or decreased during installation. The device may be attached to a location for sealing via the first and second attachment portions.

The teachings herein further envision a method for use of the device wherein the one or more projections are located into an opening upon installation of the device.

The teachings herein contemplates a device and method for the baffling and sealing of cavities with an easily modified elastic portion body having one or more attachment portions for attaching the device at varying locations, whereby the length and shape of the device is easily modified during installation.

### DESCRIPTION OF THE DRAWINGS

FIG. 1 shows a perspective view of an illustrative example of the device of the present teachings.

FIG. 2 shows a side profile view of FIG. 1.

### DETAILED DESCRIPTION

The present teachings meet one or more of the above needs by the improved composite structures and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present invention allows for improved baffling, reinforcement, and sealing of cavities that are typically reinforced with number of welded steel reinforcing sections.

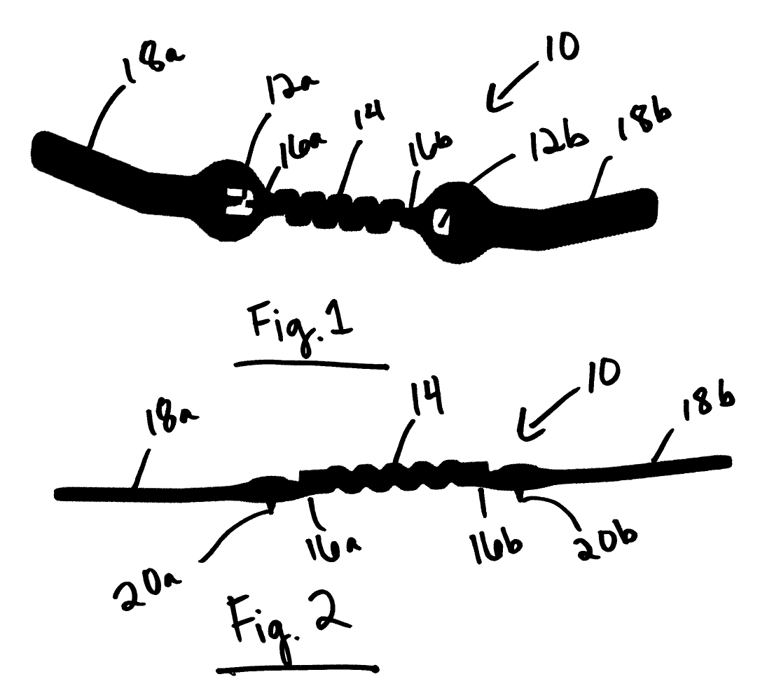

FIG. 1 shows the device 10 including a first attachment portion 12a and a second attachment portion 12b. The device 10 includes an elastic portion 14 that facilitates stretching, condensing or curving of the elastic portion 14. The elastic portion 14 is connected to the attachment portions 12a, 12b via a first connecting portion 16a and a second connecting portion 16b. The elastic portion may be integrally formed with or separately formed from the first and second attachment portions. Each attachment portion 12a and 12b may be formed adjacent a first terminating end 18a or a second terminating end 18b. FIG. 2 shows the device 10 so that a first projection 20a and second projection 20b are shown extending outwardly from the first attachment portion 12a and second attachment portion 12b, respectively.

Any of the portions described herein may include and or be formed substantially of an adhesive or seal/baffle material that is activatable. For example, the material may be activated to expand upon exposure to a stimulus. The material may be generally dry to the touch or tacky and may be shaped in any form of desired pattern, placement, or thickness, but is preferably of substantially uniform thickness. Such material may be a heat-activated material. An example of a preferred heat activated material is an expandable polymer or plastic, and preferably one that is foamable. The material may not expand. The material may be a foam having a polymeric formulation that includes one or more of an epoxy resin, an acetate (e.g. ethylene vinyl acetate), a thermoplastic polyether, an acrylate and/or a methacrylate (e.g., a copolymer of butyl acrylate and methyl acrylate), an epoxy/elastomer adduct, and one or more fillers (e.g., a clay filler, and/or a nanoparticle-containing filler). For example, and without limitation, the foam may also be an EVA/rubber based material, including an ethylene copolymer or terpolymer that may possess an alpha-olefin. As a copolymer or terpolymer, the polymer is composed of two or three different monomers, i.e., small molecules with high chemical reactivity that are capable of linking up with similar molecules. Suitable expandable materials include those available from L&L Products, Inc. under the designations L7220, L2821, L1066, L205, L2010, L2105, L2108A, L2806, L2811, L4200, L4141, L4161, L4315, L5510, L5520, L5540, L5600, L5601, L7102, and L7104.

A number of baffling or sealing foams may also be used for the seal material. A typical foam includes a polymeric base material, such as one or more ethylene-based polymers which, when compounded with appropriate ingredients (typically a blowing and curing agent), will expand and cure in a reliable and predictable manner upon the application of heat or the occurrence of a particular condition. From a chemical standpoint for a thermally-activated material, the foam is usually initially processed as a flowable material before curing, and upon curing, the material will typically cross-link making the material incapable of further flow.

The adhesive and/or seal material can be formed of other materials provided that the material selected is heat-activated or otherwise activated by an ambient condition (e.g. moisture, pressure, time or the like) and cures under appropriate conditions for the selected application. One such material is the epoxy based resin disclosed in U.S. Pat. No. 6,131,897, the teachings of which are incorporated herein by reference. Some other possible materials include, but are not limited to, polyolefin materials, copolymers and terpolymers with at least one monomer type an alpha-olefin, phenol/formaldehyde materials, phenoxy materials, and polyurethane materials with high glass transition temperatures. Additional materials may also be used such as those disclosed in U.S. Pat. Nos. 5,766,719; 5,755,486; 5,575,526; and 5,932,680, incorporated by reference herein for all purposes.

In applications where the material is a heat activated material, an important consideration involved with the selection and formulation of the material is the temperature at which a material cures and, if expandable, the temperature of expansion. Typically, the material becomes reactive (cures, expands or both) at higher processing temperatures, such as those encountered in an automobile assembly plant, when the material is processed along with the automobile structures at elevated temperatures or at higher applied energy levels, e.g., during coating (e.g., e-coat, paint or clearcoat) curing steps. While temperatures encountered in an automobile assembly operation may be in the range of about 148.89° C. to 204.44° C. (about 300° F. to 400° F.) for body shop applications (e.g., e-coat) and, for paint shop applications, are commonly about 93.33° C. (about 200° F.) or slightly higher (e.g., 120° C.-150° C.).

The first and third attachment portions may include a combination of openings and projections (or only an opening or projection) for connecting the device to a desired location. The device may include two opposing attachment portions so that the device can be connected to two distinct locations such that elastic portion may be lengthened when both attachment portions are connected to a location during installation. The attachment portions may also be provided in a variety of shapes and in a variety of configurations so long as it can secure one member to another. The fastener may be capable of securing multiple layers or types of materials to one another. Examples of suitable shapes and formations of the attachment portions include mechanical fasteners, clips, tabs, press-fits, snap-fits, screws, hooks, combinations thereof or the like. Furthermore, it is contemplated that the one or more of the attachment portions may be formed integral of a singular material with the material of the elastic portion and/or terminating ends or may be formed of a different material and may be removably attached to the elastic portion and/or terminating ends.

The device of the present invention may be installed into an automotive vehicle although it may be employed for other articles of manufacture such as boats, buildings, furniture, storage containers or the like. The device may be used to seal, reinforce and/or baffle a variety of components of an automotive vehicle including, without limitation, body components (e.g., panels), frame components (e.g., hydroformed tubes), pillar structures (e.g., A, B, C or D-pillars), bumpers, roofs, bulkheads, instrument panels, wheel wells, floor pans, door beams, hem flanges, vehicle beltline applications, doors, door sills, rockers, decklids, hoods or the like of the automotive vehicle.

Formation of the materials of the present invention may include a variety of processing steps depending on the desired configuration of the materials. The device may be formed by an extrusion process, a molding process, or a pultrusion process. Additional processing and formation steps may not be required.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the Detailed Description of the Invention of a range in terms of at “‘x’ parts by weight of the resulting polymeric blend composition” also contemplates a teaching of ranges of same recited amount of “x” in percent by weight of the resulting polymeric blend composition.”

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. By use of the term “may” herein, it is intended that any described attributes that “may” be included are optional.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1: A device for sealing or baffling a cavity comprising:
a first attachment portion;
a second attachment portion opposing the first attachment portion;
an elastic portion located in between the first and second attachment portions so that the length of the elastic portion can be modified during installation;
wherein the elastic portion comprises an activatable material and is integrally formed with the first and second attachment portion.

2: A device as in claim 1, wherein one or more of the first and second attachment portions include an opening.

3: A device as in claim 1, wherein both of the first and second attachments include an opening.

4: A device as in claims 1, wherein one or more of the first and second attachment portions include at least one integrally formed projection.

5: A device as in claim 1, wherein both of the first and second attachment portions include at least one integrally formed projection.

6: A device as in claim 1, wherein the at least one integrally formed projection extends outward from an opening.

7: The device of claim 1, wherein the entirety of the device is integrally formed of one material.

8: The device of claim 1, wherein the entirety of the device is integrally formed of an activatable material.

9: The device of claim 1, wherein the entirety of the device is integrally formed of an activatable material that foams and/or cures upon exposure to elevated temperatures.

10: The device of claim 1, wherein the elastic portion is shaped in an accordion shape to allow for the length of the elastic portion to be increased or decreased during installation.

11: A method for use of the device of claim 1, wherein the device is attached to a location for sealing via the first and second attachment portions.

12: A method for use of the device of claim 1, wherein the one or more projections are located into an opening upon installation of the device.
